(19) United States
(12) Patent Application Publication
(10) Pub. No.: US 2018/0250716 A1
(43) Pub. Date: Sep. 6, 2018

(54) VACUUM NOZZLE

(71) Applicant: DE BEERS UK LTD, London, Greater London (GB)

(72) Inventors: Luke SMITH, Buckinghamshire (GB); Peter ROSE, Buckinghamshire (GB)

(21) Appl. No.: 15/758,046

(22) PCT Filed: Sep. 6, 2016
(86) PCT No.: PCT/GB2016/052743

§ 371 Date: Mar. 7, 2018

(30) Foreign Application Priority Data
Sep. 8, 2015 (GB) 1515912.2

(51) Int. Cl. B07C 5/36; B65G 47/91

(52) U.S. Cl. CPC B07C 5/365; B65G 47/914

(57) ABSTRACT

A method of and an apparatus for picking up cut gemstones which have been orientated table down is provided. A vacuum wand has a generally cylindrical body with a central bore culminating in a nozzle through which a vacuum may be applied. The wand comprises a retractable outer sleeve configured to slide axially over the nozzle, and a biasing mechanism for biasing the sleeve towards a position in which it extends beyond the nozzle.

### TECHNICAL FIELD

The present invention relates to a method and an apparatus for picking up cut gemstones which have been previously orientated. In particular, although not exclusively, the invention relates to a method and an apparatus for picking up cut diamonds.

### BACKGROUND

Natural diamonds are stones from nature, consisting exclusively of diamond formed by geological processes over long periods of time. Synthetic diamonds are man-made stones manufactured by industrial processes, such as HPHT (high pressure high temperature) and CVD (chemical vapour deposition). Synthetic diamonds may be relatively easy to distinguish from natural diamonds when in an unpolished state, however, once polished and cut into a gemstone, identification that a stone is synthetic may be more difficult.

Advanced screening instruments, such as the DiamondSure™ and DiamondView™ may be used to test whether a stone is natural or synthetic. Typically, such screening involves measuring the way in which light is absorbed by or emitted from a diamond. Before screening commences it is usually necessary for the stone being tested to be placed “table-down” in a precise location on the measurement surface or holder. In this context, the “table” is the largest central facet of the crown (the top half of the stone when mounted).

In addition to screening larger, individual stones, it is also necessary to screen large numbers of smaller diamonds, including stones sometimes known as melee. Melee is a term of the trade that does not have a well defined size range, but can be considered in practice to refer to stones smaller than about 0.2 carats (20 points), and usually (but not necessarily) larger than about 0.01 or 0.02 carats. Due to their small size, melee stones are typically sold in parcels or lots. Since one parcel may contain hundreds of stones, it is possible for synthetic diamonds to be mixed in with natural stones.

Screening of melee diamonds can potentially be extremely time consuming, since each stone must be tested individually and therefore placed in the correct orientation individually. WO 2012/146913 discloses an apparatus for orientating gemstones, in which discrete gemstones are provided on a travelling path which has a pair of opposed oscillating walls. These walls urge the gemstones into their most stable orientation—i.e. table-down—as they progress along the path. Once in this orientation, individual stones can be lifted from the travelling path by a vacuum wand and transported to a test station.

FIG. 1 is a view of the apparatus 1 described in WO 2012/146913 for orientating gemstones. The melee stones are poured into a hopper 2 and pass through a pair of rollers 6. The speed of the rollers 6 is configured to separate out the stones so they pass through one at a time. The stones are then directed onto a rotating disc 10, as shown in FIG. 2. The disc 10 rotates clockwise and provides a circular travelling path, passing the stones through an agitator 13. The agitator 13 comprises a pair of opposed parallel vertical walls 11 which form a semi-circular channel 12. The walls 11 are connected to an oscillator 15 which oscillates the walls with sufficient magnitude and frequency that they collide with the stones on the travelling path. The centre of the pair of walls 14 oscillates along the radius of the rotating disc 10.

The impact level of the walls 11 is chosen such that it is enough to knock a stone off its pavilion facet, but not to knock a stone off its most stable table facet. Eventually, the stones land table-down and are aligned by the time they reach a handling area 7. An orientation checking device 9 checks that each stone is table-down, by recording a side view silhouette image of the stone with a camera 16. If the stone is found to be correctly orientated, it is collected by the handler, comprising a swinging arm 3 and a vacuum wand 4, and transported to a synthetic detection device 17. If the stone is found to be incorrectly orientated, it will be transported back to the oscillating channel 12 to be re-orientated. This process continues until all stones in the melee have been orientated, tested and dispensed into an appropriate collection bin 5 via chutes 8.

Diamonds which are to be sorted and tested using apparatus including the melee screener described above may comprise a wide range of sizes and cuts. Popular diamond cuts range from round brilliant to pear shaped to elongate baguette cuts. Stones which require screening may vary in size from small melee diamonds to much larger individual stones. In order to sort and process stones for testing quickly, it is desirable to be able to handle a wide variety of sizes and cuts using the same apparatus. Moreover, since each stone to be screened must be very precisely placed upon the measurement surface, it is desirable for the apparatus to be capable of precise positioning, regardless of variations in stone size or cut.

FIG. 3a is a cross section of a stone held by a conventional nozzle. A 1 point cut stone (girdle 1.4 mm, depth 0.83 mm) has been picked up by the nozzle of a conventional vacuum wand. It will be noted that the stone is positioned centrally, with its culet in the centre of the nozzle. FIG. 3b shows the same stone, but in this case the nozzle has been lowered down onto the stone off centre, so that the stone is located on one side of the nozzle. Using this conventional nozzle, the stone may be as much as 0.3 mm off centre while still within nozzle, with the added potential for its position to move as it is transported. Furthermore, there is a significant danger in this situation that the stone will rotate as vacuum is applied to the nozzle so as to pick up the stone, meaning it is no longer table down, and is unlikely to be deposited table down when released from the nozzle onto the measurement instrument. Therefore, while the precise position of the nozzle can be guaranteed, the precise position of the stone within the nozzle cannot, and this may lead to incorrect positioning and/or orientation of the stone on the measurement surface and hence invalid test or measurement results.

### SUMMARY

In accordance with one aspect of the present invention there is provided a vacuum wand for picking up cut gemstones which have been orientated table down, having a generally cylindrical body with a central bore culminating in a nozzle through which a vacuum may be applied, said wand comprising a retractable outer sleeve configured to slide axially over the nozzle, and a biasing mechanism for biasing the sleeve towards a position in which it extends beyond the nozzle.

The vacuum wand may be configured so that the sleeve cannot rotate relative to the nozzle.

The sleeve may be provided with a flat surface which co-operates with a flat surface of the cylindrical body to prevent the rotation of the sleeve relative to the nozzle.

The nozzle may be provided with a contact surface at a lower end thereof configured to retain a relatively small cut gemstone when vacuum is applied to the bore.

The contact surface of the nozzle may be tapered inwards.

The contact surface of the nozzle may be provided with a profiled groove extending transversely therethrough.

The sleeve may be provided with a contact surface at a lower end thereof, configured to retain a relatively large cut gemstone when vacuum is applied to the bore.

The contact surface of the sleeve may be tapered inwards.

The contact surface of the sleeve may be provided with a profiled groove extending transversely therethrough, circumferentially aligned with the groove of the nozzle

An outer end of the profiled groove of the nozzle may be of substantially the same width as an inner end of the profiled groove of the sleeve.

The sleeve may be configured to retract axially over the nozzle when a gemstone being picked up has a smaller diameter than an internal diameter of the sleeve.

The sleeve may be movable between an extended position, in which the contact surface of the sleeve is level with or below the contact surface of the nozzle, and a retracted position, in which the contact surface of the sleeve is above the contact surface of the nozzle.

The biasing mechanism may comprise a spring.

Retraction of the sleeve may be limited by a shoulder of the wand body and co-operation between an upper flat surface of the sleeve and the wand body.

The sleeve may be held in place on a distal end of the wand body by interlocking engagement with lugs

A biasing force of the biasing mechanism may be sufficient to return the sleeve from the retracted to the extended position. The biasing force may be insufficient to dislodge a gemstone retained by the contact surface of the nozzle and/or the sleeve when the sleeve is returned to the extended position.

A transport mechanism for transporting cut gemstones may comprise a pivotable arm attached to a vacuum wand according to the first aspect above. A gemstone testing station may comprise a device for orienting cut gemstones table down, the aforementioned transport mechanism, and an analysis instrument for carrying out analysis of the gemstones. A screening device for determining whether a cut gemstone is natural or synthetic may include the aforementioned testing station.

In accordance with another aspect of the present invention there is provided a method of picking up a cut gemstone which has been orientated table down, comprising the steps of providing a vacuum wand having a generally cylindrical body with a central bore culminating in a nozzle through which a vacuum may be applied, the wand comprising a retractable outer sleeve, configured to slide axially over the nozzle and a biasing mechanism for biasing the sleeve towards a position in which it extends beyond the nozzle; bringing the wand into contact with a pavilion of a gemstone; applying a vacuum through the bore to the nozzle; where the gemstone has a diameter greater than or equal to an internal diameter of the sleeve, retaining the gemstone by air pressure against the sleeve and/or the nozzle; or where the gemstone has a diameter smaller than the internal diameter of the sleeve, retracting the sleeve and retaining the gemstone by air pressure against the nozzle only.

The sleeve may comprise a flat surface which co-operates with a flat surface of the cylindrical body to prevent rotation of the sleeve relative to the nozzle.

The nozzle may comprise a tapered contact surface at a lower end thereof, configured to retain a cut gemstone when vacuum is applied to the bore.

The sleeve may comprise a generally conical contact surface at a lower end thereof, configured to retain a cut gemstone when vacuum is applied to the bore.

The contact surface of the nozzle may be provided with a profiled groove extending transversely therethrough.

The contact surface of the sleeve may be provided with a profiled groove extending transversely therethrough, being circumferentially aligned with the groove of the nozzle.

The sleeve may be movable between an extended position, in which the contact surface of the sleeve is level with or below the contact surface of the nozzle, and a retracted position, in which the contact surface of the sleeve is above the contact surface of the nozzle.

The biasing mechanism may comprise a spring.

A biasing force of the biasing mechanism may be configured to be sufficient to return the sleeve from the retracted to the extended position, but insufficient to dislodge a gemstone retained by the contact surface of the nozzle and/or the sleeve when the sleeve is returned to the extended position.

A method of picking up and transporting cut gemstones of a variety cuts and sizes which have been orientated table down may use the method of the second aspect above and the same vacuum wand to pick up each gemstone.

### BRIEF DESCRIPTION OF THE DRAWINGS

FIG. 1 is a perspective view of a known apparatus for orientating gemstones;

FIG. 2 is a plan view of the apparatus of FIG. 1, with components removed for clarity;

FIG. 3a is a cross section of a conventional vacuum nozzle holding a cut stone;

FIG. 3b is a further cross section of the vacuum nozzle and stone of FIG. 3a;

FIG. 4a is a perspective view of a vacuum wand for picking up cut stones;

FIG. 4b is a cross section of the vacuum wand of FIG. 4a;

FIG. 5a is an enlarged view of an end of the vacuum wand of FIG. 4a;

FIG. 5b is an enlarged view of the end of the vacuum wand of FIG. 5a;

FIG. 6 is a side view of the wand of FIG. 4 holding a 20 point brilliant cut stone;

FIG. 7a is a side view of the vacuum wand of FIG. 4;

FIG. 7b is a side view of the vacuum wand of FIG. 4, holding a 1 point brilliant cut stone in the pick up position;

FIG. 7c is a side view of the vacuum wand of FIG. 4, holding a 1 point brilliant cut stone in the transport position;

FIG. 8 is a perspective view of the wand holding a 1 point brilliant cut stone;

FIG. 9a is a perspective view of the wand holding a large baguette cut stone;

FIG. 9b is a perspective view of the wand holding a small baguette cut stone; and

FIGS. 10a to 10h are perspective views of the wand holding a variety of different cut stones.

### DETAILED DESCRIPTION

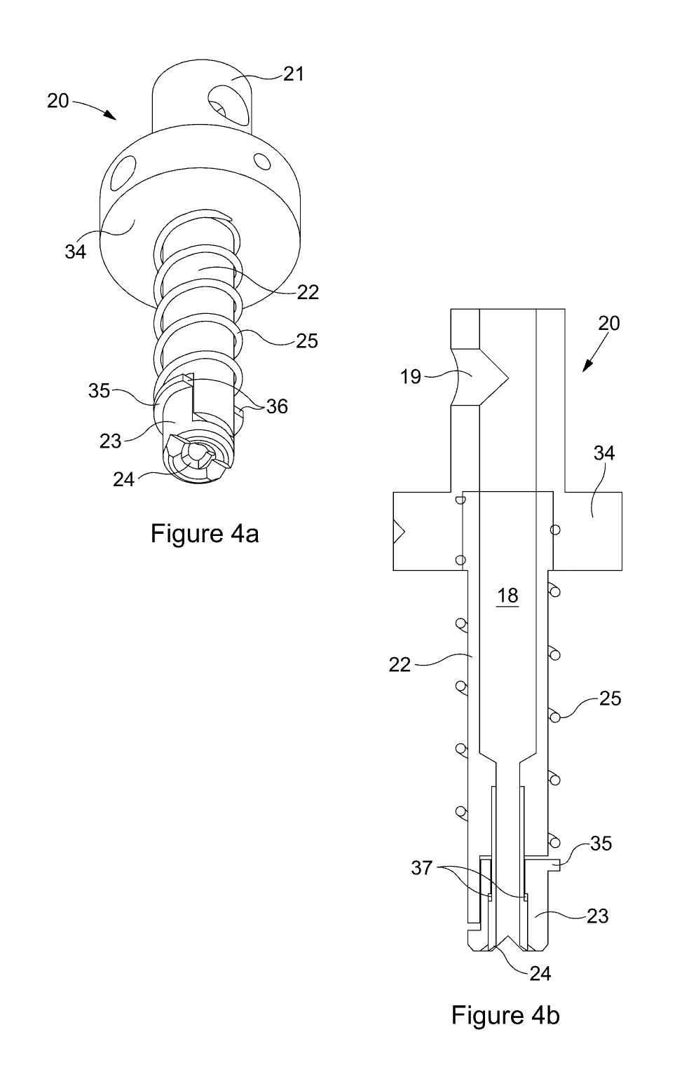

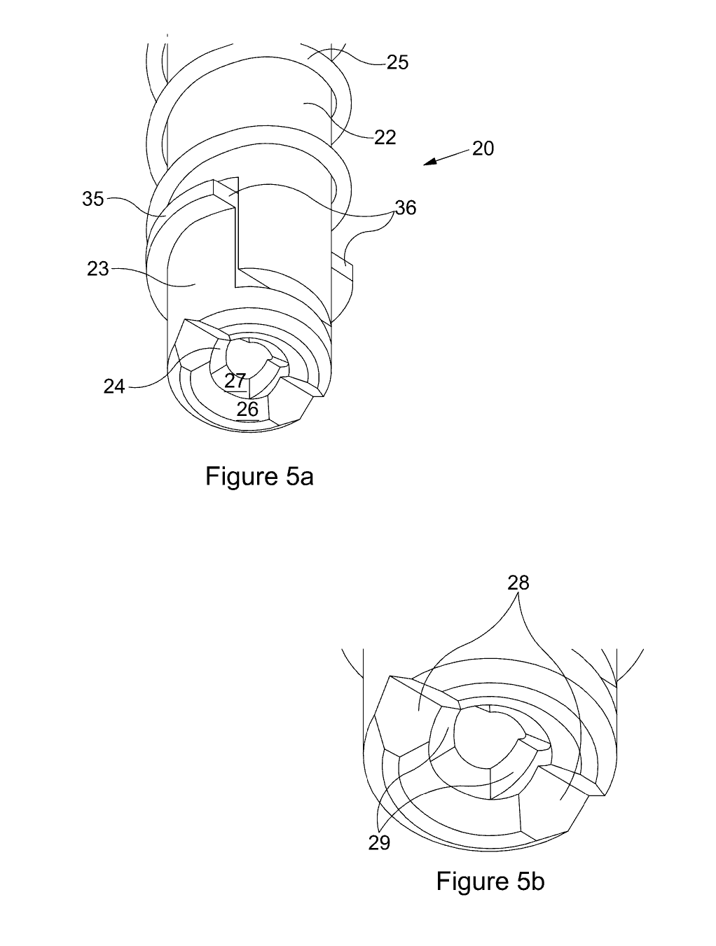

FIG. 4a is a perspective view of a vacuum wand 20 for picking up cut gemstones, such as diamonds. FIG. 4b is a cross-sectional view of the wand 20. FIGS. 5a and 5b are close up views of a nozzle 24 located at the end of the wand of FIG. 4a. The wand is designed to be used to pick up stones which have been previously orientated so that they are table down. This orientation may be performed by an automatic gemstone orientation apparatus, as discussed above.

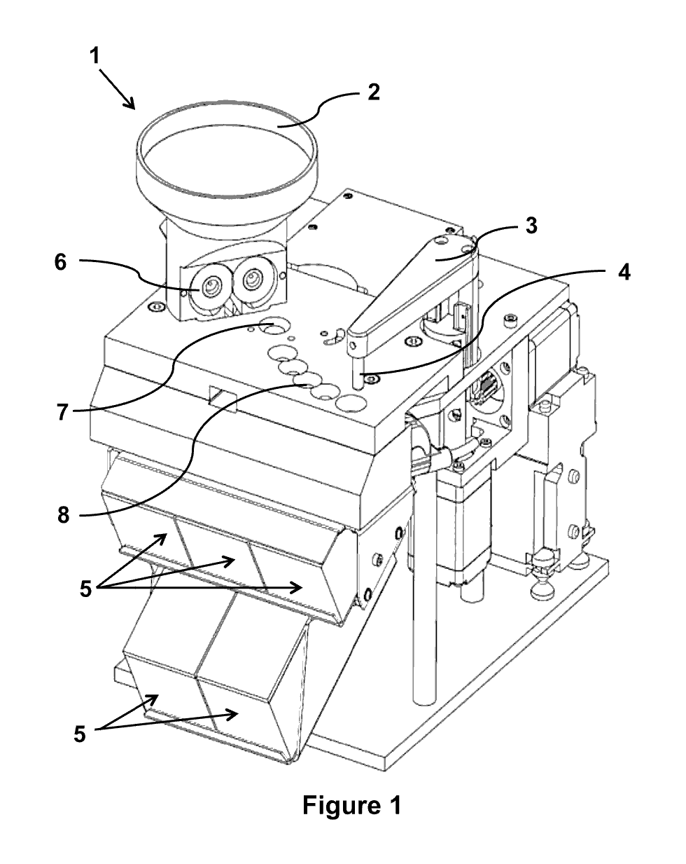

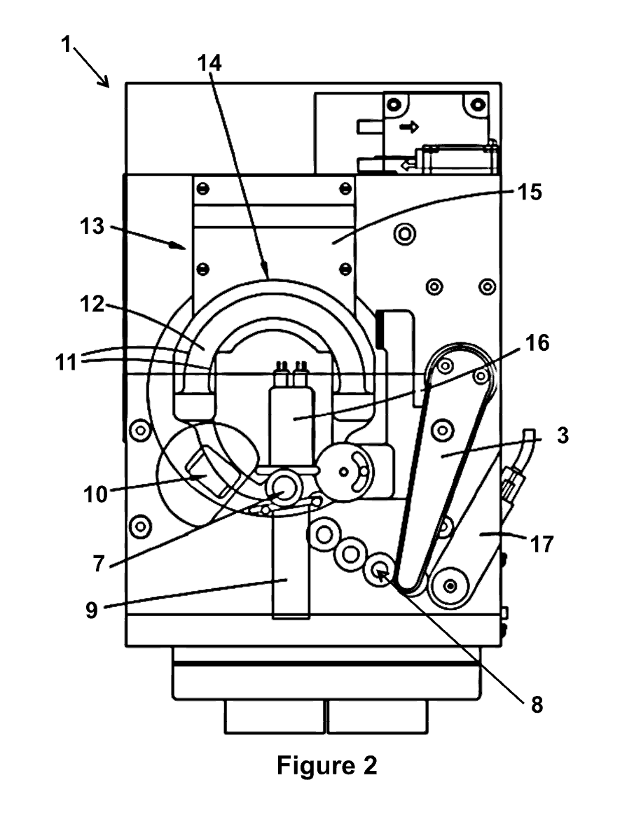

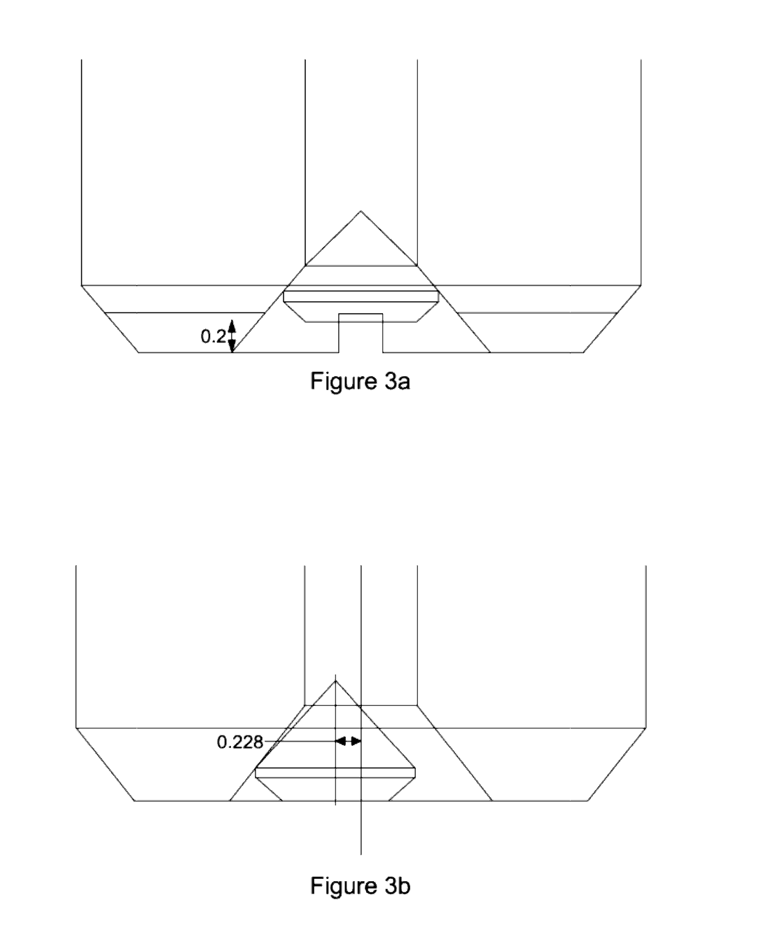

The wand 20 comprises an engagement portion 21, by which it may be fixed to a swinging arm similar to the arm 3 shown in FIG. 1. A cylindrical wand body 22 having a bore 18 therethrough is connected to the engagement portion 21. At a distal end of the wand body 22 the bore 18 ends in an inner fixed tapered nozzle 24 which is surrounded by a retractable outer sleeve 23, configured to slide axially over the body 22 and past the nozzle 24. When a vacuum is applied to the bore 18 (e.g. through port 19) a gemstone located in the nozzle 24 will be picked up and retained within the nozzle 24 and sleeve 23 by air pressure. In this example both the sleeve 23 and inner nozzle 24 are substantially circular in shape.

The sleeve 23 and nozzle 24 both have contact surfaces 26, 27 respectively at lower ends thereof. The sleeve 23 is moveable between an extended position, in which the contact surface 26 of the sleeve 23 is level with or below the contact surface 27 of the nozzle 24, and a retracted position, in which the contact surface 26 of the sleeve 23 is above the contact surface 27 of the nozzle 24. The sleeve is biased towards the extended position, in this example by a spring 25 so that the sleeve is spring loaded. The sleeve 23 can therefore slide axially over the nozzle 24. The spring 25 is braced against a shoulder 34 of the wand body 22 at one end and against a flat upper surface 35 of the sleeve 23 at the other.

The sleeve 23 is prevented from rotating relative to the nozzle 24 by flats 36 which abut the distal end of the wand body 22. Likewise, the flat upper surface 35 of the sleeve 23 abuts the wand body 21 when the sleeve 23 is in the retracted position, which prevents the sleeve 23 from retracting further. The sleeve 23 is held in place on the distal end of the wand body 21 by interlocking engagement with lugs 37.

In this illustrated example, the inner nozzle 24 is provided with a tapered contact surface 26 against which a generally conical surface of a cut stone can be retained by air pressure when vacuum is applied through the bore. The sleeve 23 is similarly provided with a tapered contact surface 27 against which a portion of a surface of a cut stone can be retained when the nozzle is under vacuum. As can be seen from FIG. 5a, these contact surfaces 26, 27 are tapered from an outer diameter of the sleeve 23 to an inner diameter of the nozzle 24.

As shown in FIG. 5b, both the sleeve 23 and inner nozzle 24 are provided with profiled grooves 28, 29. These grooves 28, 29 run radially through the contact surfaces 26, 27 of the nozzle 24 and sleeve 23, from an outer diameter of the sleeve 23 to an inner diameter of the nozzle 24. The grooves 28 of the sleeve 23 are circumferentially aligned with the grooves 29 of the nozzle 24. The profile of the grooves 28, 29 is generally tapered or v-shaped. It will be appreciated that this profile is particularly suited to accommodate a culet or keel of a cut stone. An outer end of the profiled groove 29 of the nozzle 24 is of substantially the same width as an inner end of the profiled groove 28 of the sleeve 23. The grooves 28, 29 therefore form a continuous channel across the contact surfaces 26, 27 of the nozzle 24 and sleeve 23.

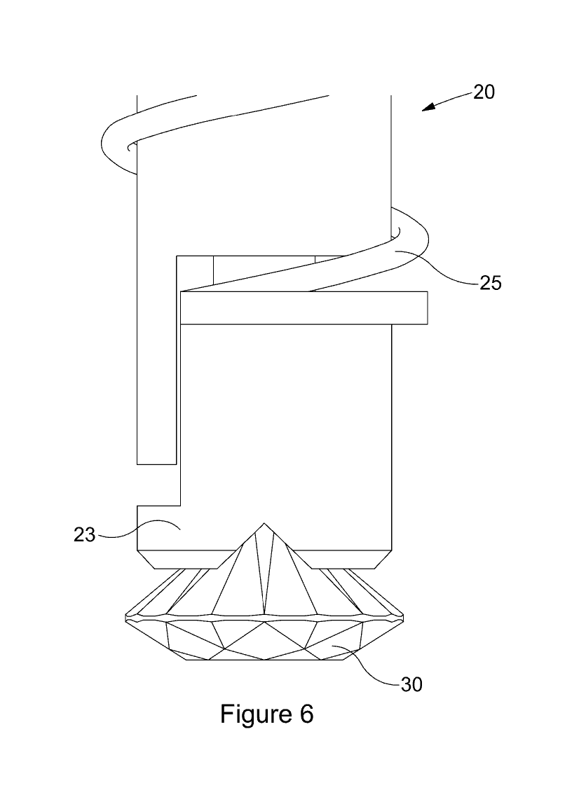

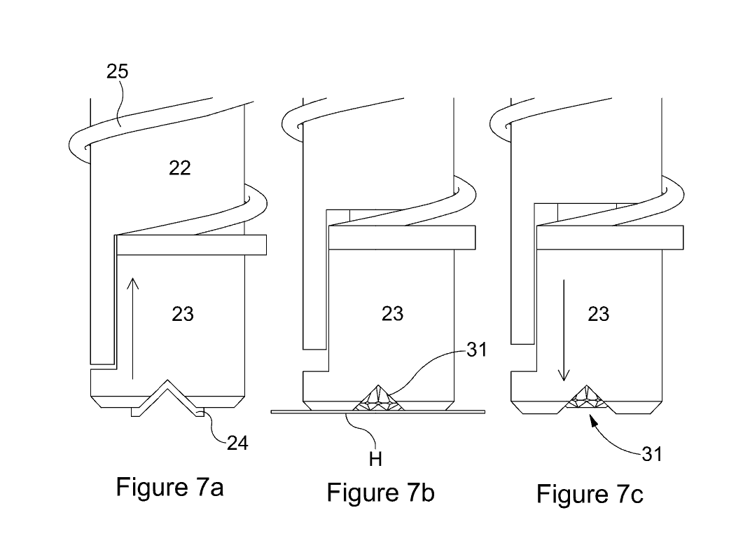

The operation of the vacuum wand 20 will now be described with reference to FIGS. 6 and 7, which show side views of the distal end of the wand.

FIG. 6 shows the vacuum wand 20 holding a 20 point (0.2 carat) round brilliant cut stone. A round brilliant cut stone has a substantially round girdle, a generally conical pavilion and a crown with a flat facet (table) on an upper surface. In FIG. 6, the stone 30 is orientated table-down. Stones which have been subjected to an automated orientation process, as discussed above, may be roughly positioned under the nozzle 24. The nozzle 24 is lowered onto the stone 30 which is orientated table down on a handling surface (not shown here). The stone 30 is precisely centred by the sleeve 23, either by relative motion of the stone 30 or of the nozzle 24.

In the example of FIG. 6, the diameter of stone 30 is larger than an internal diameter of the sleeve 23, and so the stone 30 may simultaneously come into contact with both the inner nozzle 24 and the sleeve 23. The stone 30 is retained by air pressure against both the contact surfaces 26, 27 of the nozzle 24 and the sleeve 23. Alternatively, the stone 30 may be in contact with the contact surface 26 of the sleeve 23 only, depending upon the stone's diameter and angular shape of the crown. The outer diameter of the sleeve 23 comes into contact with the stone 30, and not with the handling surface on which the stone 30 has been orientated table down. The sleeve 23 therefore remains biased by the spring 25 into an extended position, in which the contact surface 26 of the sleeve 23 is level with or below the contact surface 27 of the nozzle 24. The stone 30 is centred to the nozzle 24 upon pick up and can therefore be transported to one or more of: a testing station, a measurement station, a further processing system. The stone 30 may then be precisely placed thereon.

In the example of FIGS. 7a to 7c, the stone 31 is a 1 point brilliant cut stone, having a diameter smaller than the internal diameter of the sleeve 23. In this case, the sleeve 23 will retract up over the nozzle 24, in the direction illustrated by the arrow shown in FIG. 7a.

As the nozzle 24 is lowered over the stone 31, the retractable sleeve 23 makes contact with the handling surface H, as shown in FIG. 7b, and is pushed axially up over the nozzle. It will be appreciated that the axial movement of the sleeve 23 relative to the fixed nozzle 24 causes compression of the spring 25. The sleeve 23 makes contact with the handling surface H first, and retracts as the nozzle 24 descends until the nozzle contacts the stone 31. This is in contrast to the large stone 30 shown in FIG. 6 where the sleeve 23 and nozzle 24 simultaneously make contact with the stone 30.

As illustrated in FIG. 7a, compression of the spring 25 and retraction of the sleeve 23 in the direction indicated by the arrow is limited by the shoulder 34 of the wand body 22 and co-operation between the upper flat surface 35 of the sleeve 23 and the wand body 21. This ensures that the spring 25 is not over-compressed and prevents damage to the nozzle 24.

After pick up, the vacuum wand 20 is raised to prepare for transport. As the wand 20 is raised the spring 25 is no longer compressed by the handling surface and therefore the sleeve 23 is biased into an extended position once again, moving axially over body past the inner nozzle 24 in a direction indicated by the arrow shown in FIG. 7c. In other words, the sleeve 23 moves back down the wand 20 around the stone 31.

It will be appreciated that as the wand is lowered onto a measurement surface (not shown here), the sleeve 23 will contact the surface and again retract around the stone 31. The vacuum is then released to place the stone 31 on the measurement surface. As the stone 31 has been precisely centred to the nozzle 24 and has been retained against the contact surface 27 of the nozzle 24 during transport, there has been no opportunity for the stone 31 to move around or to rotate within the nozzle 24 and therefore the stone 31 will be precisely placed table down by the vacuum wand 20 upon the measurement surface or holder.

FIGS. 6 and 7 illustrate the operation of the wand 20 in relation to a stone 30 (hereinafter referred to as a medium-sized stone) which is larger than the external diameter of the sleeve 23 and to a stone 31 which has a diameter smaller than the internal diameter of the sleeve 23. In a case where a stone has a diameter just smaller than the external diameter of the sleeve 23 but larger than an external diameter of the nozzle 24, the stone may be in contact with the contact surfaces 26, 27 of both the nozzle 24 and the sleeve 23 at the point of pick up. However, when the stone is lifted off the handling surface and the sleeve 23 is biased back to an extended position, the stone may be retained against the contact surface 27 of the inner nozzle 24 only.

The force at which the sleeve 23 is biased back into the extended position is therefore of great importance. If the biasing force is too weak, the sleeve 23 may not return to the extended position. If the biasing force is too strong, it may dislodge the medium-sized stone from its position against the contact surface 27. The strength of the biasing force provided by the spring 25 is therefore carefully configured to be just strong enough to return the sleeve 23 to the extended position.

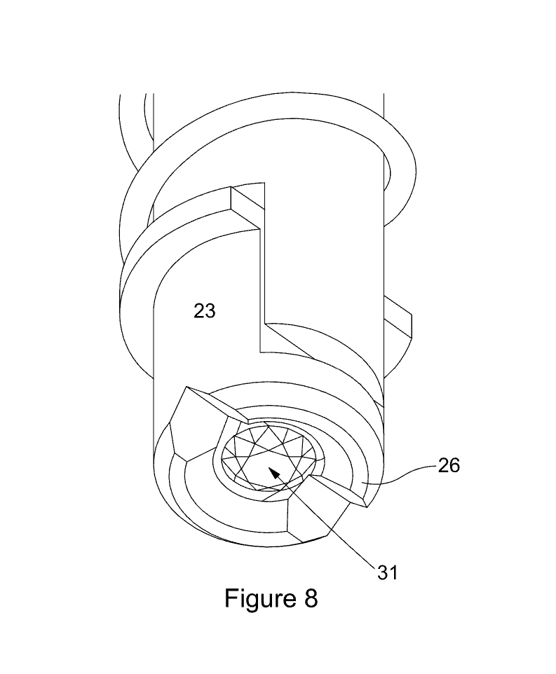

FIG. 8 is a perspective view of the 1 point stone 31 retained against the contact surface 27 of the inner nozzle 24. The stone 31 is precisely centred to the nozzle 24 but since its diameter is less than that of the inner diameter of the sleeve 23, the stone 31 is not in contact with the contact surface 26 of the sleeve 23. The stone 31 will not come into contact with the sleeve 23 either on pick-up, during transport or when the stone 31 is placed upon the measurement surface or holder.

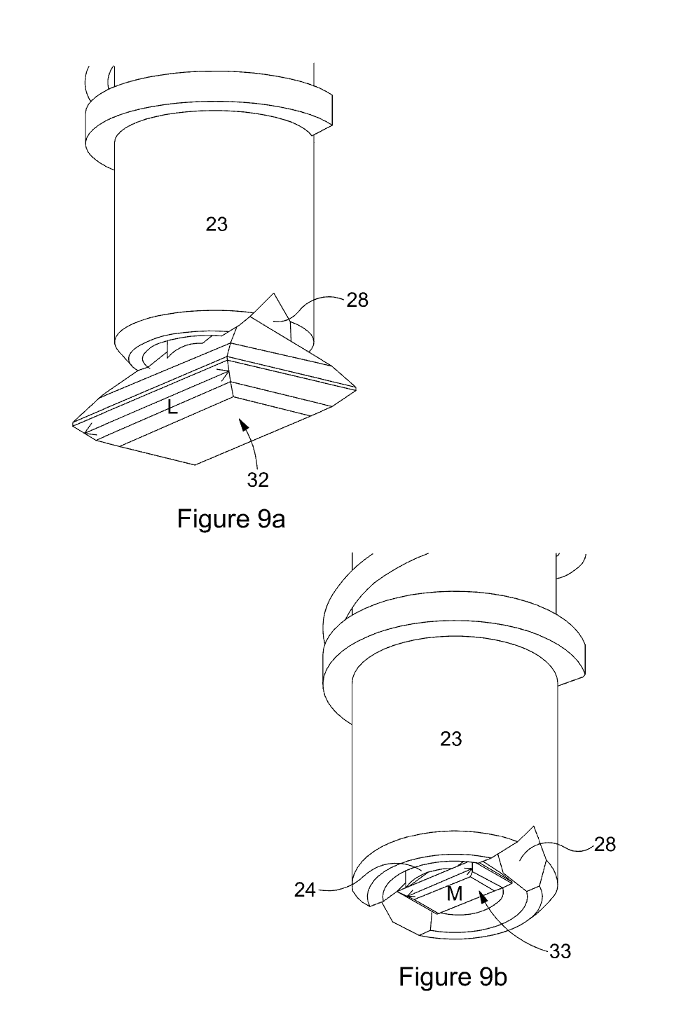

The operation of the profiled grooves 28, 29 will now be described with reference to FIGS. 9a and 9b. Stones 32, 33 shown in FIGS. 9a and 9b are elongate baguette cut stones, 20 points and 1 point respectively in size, being substantially rectangular in cross section and having one axis longer than the other. As discussed with reference to FIG. 5b, the sleeve 23 and inner nozzle 24 are provided with profiled grooves 28, 29, which run transversely across the contact surfaces 26, 27 of the nozzle 24 and sleeve 23.

The grooves 28 of the sleeve 23 are circumferentially aligned with the grooves 29 of the nozzle 24. This alignment provides substantially continuous channels from an inner diameter of the nozzle 24 to the outer diameter of the sleeve 23. The grooves 28, 29 can therefore accommodate the long axis of a fancy cut stone, such as the 20 point baguette cut stone 32 shown in FIG. 9a. The tapered profile of the grooves 28, 29 is also suitable for stones which may have a flat keel rather than a pointed culet.

Prior to pick up by the vacuum wand 20, the stone 32 is orientated table down by an automatic orientation device, such as the one discussed above. In addition to orientating cut stones table down, the device will also orient stones axially, i.e. a stone with one longer axis, such as a baguette cut stone, will generally be longitudinally orientated in the same way by the orientation device. The longitudinal orientation of the stone 32 when it reaches the handling area is therefore known, and the vacuum wand 20 may be installed such that the orientation of the long axis of the stone 32 and the orientation of the grooves 28, 29 are aligned.

The operation of the vacuum wand 20 is substantially as described above with reference to FIG. 6. Where the stone to be picked up has a length L longer than or equal to the outer diameter of the sleeve 23, the stone 32 is retained by air pressure against both the contact surfaces 26, 27 of the nozzle 24 and the sleeve 23. The outer diameter of the sleeve 23 does not come into contact with the handling surface and therefore remains biased by the spring 25 into an extended position. The stone 32 is centred to the nozzle 24 by the grooves 28, 29 upon pick up and can therefore be transported to one or more of: a testing station, a measurement station, a further processing system. The stone 32 can then be precisely placed thereon.

FIG. 9b illustrates the operation of the wand 20 with a 1 point baguette cut stone 33. In this case and as described with reference to FIGS. 7a to 7c, the length M of the stone 33 is less than the internal diameter of the sleeve 23 and therefore the retractable sleeve 23 makes contact with the handling surface (not shown here) and is pushed axially up over the nozzle 24 as the nozzle continues to descend until it makes contact with e stone 33. The stone 33 may be precisely centred to the nozzle 24 and within the profiled grooves 29. As can be seen in FIG. 9b, the stone 33 once retained by the wand 20 is centrally held against the contact surface 27 of the nozzle 24 only, and not against the contact surface 26 of the sleeve 23. Hence the stone 33 will not move around or rotate during transport and can be precisely positioned table down on a measurement surface or holder.

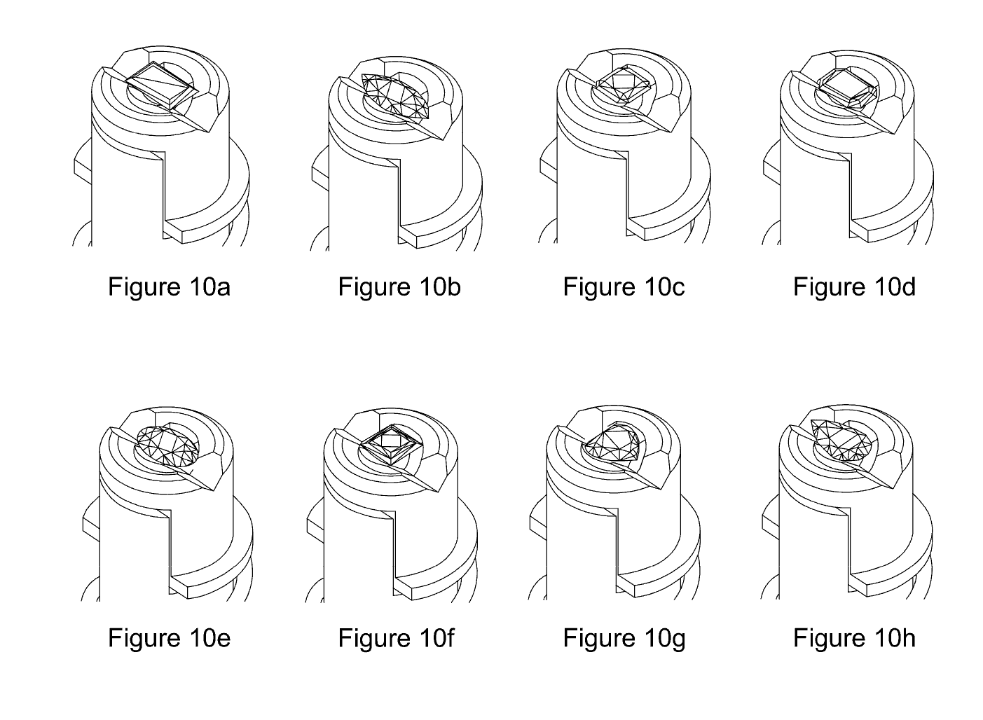

It will be appreciated that the vacuum wand 20 described herein may be to pick up and transport cut gemstones of many different cuts and sizes. For example, the same wand 20 may be used to pick up both brilliant round and fancy cut stones, as shown in FIGS. 10a to 10h, including but not limited to: baguette (as shown in FIG. 10a), marquise (as shown in FIG. 10b), radiant (as shown in FIG. 10c), emerald (as shown in FIG. 10d), oval (as shown in FIG. 10e), princess (as shown in FIG. 10f), heart (as shown in FIG. 10g), pear (as shown in FIG. 10h), and carre cuts. The sprung mechanism of the wand 20 permits handling and placement of an extensive range of stone sizes, for example (but not limited to) 1 to 35 point round cut stones, and 1 to 20 point fancy cut stones. The configuration of the wand 20 ensures that even small stones do not rotate as vacuum is applied to the nozzle 24 so as to pick up the stone, meaning it will remain orientated in a table down position when released from the nozzle 24 onto the measurement instrument.

The ability to use the same wand 20 for a wide range of stone cuts and sizes, whilst still ensuring precise placement of the stone for measuring or test purposes, may be advantageous in speeding up or streamlining existing apparatus for sorting, testing and/or measuring cut stones.

It will be appreciated by the person skilled in the art that various modifications may be made to the above described embodiments, without departing from the scope of the present invention.

The retractable sleeve may be biased by means other than a spring, for example, by magnetic means.

The size and profile of the grooves in the sleeve and nozzle contact surfaces may vary according to the requirements of the application. The configuration of the sleeve and nozzle contact surfaces may vary, for example, the contact surfaces may be flat, or they may be treated or configured to provide additional grip.

The inner and outer diameters of the sleeve and nozzle may vary in size as required. The sleeve and/or the nozzle may not be substantially circular; they may have an oval or irregular profile.

The nozzle, sleeve, wand body and spring may comprise a metal, or may comprise a plastic material.

While it is envisaged that the wand as herein described may be used with conventional sorting and measuring equipment, the wand may have uses with other types of equipment.

1. A vacuum wand for picking up cut gemstones which have been orientated table down, having a generally cylindrical body with a central bore culminating in a nozzle through which a vacuum may be applied, said wand comprising a retractable outer sleeve configured to slide axially over the nozzle, and a biasing mechanism for biasing the sleeve towards a position in which it extends beyond the nozzle.

2. A vacuum wand as claimed in claim 1, configured so that the sleeve cannot rotate relative to the nozzle.

3. A vacuum wand as claimed in claim 2, wherein the sleeve is provided with a flat surface which co-operates with a flat surface of the cylindrical body to prevent the rotation of the sleeve relative to the nozzle.

4. A vacuum wand as claimed in claim 1, wherein the nozzle is provided with a contact surface at a lower end thereof, said surface configured to retain a relatively small cut gemstone when vacuum is applied to the bore.

5. A vacuum wand as claimed in claim 4, wherein the contact surface of the nozzle is tapered inwards.

6. A vacuum wand as claimed in claim 4, wherein the contact surface of the nozzle is provided with a profiled groove extending transversely therethrough.

7. A vacuum wand as claimed in claim 1, wherein the sleeve is provided with a contact surface at a lower end thereof, said surface configured to retain a relatively large cut gemstone when vacuum is applied to the bore.

8. A vacuum wand as claimed in claim 7, wherein the contact surface of the sleeve is tapered inwards.

9. A vacuum wand as claimed in claim 7, wherein the contact surface of the sleeve is provided with a profiled groove extending transversely therethrough, said groove being circumferentially aligned with the groove of the nozzle.

10. A vacuum wand as claimed in claim 9, wherein an outer end of the profiled groove of the nozzle is of substantially the same width as an inner end of the profiled groove of the sleeve.

11. A vacuum wand as claimed in claim 1, wherein the sleeve is configured to retract axially over the nozzle when a gemstone being picked up has a smaller diameter than an internal diameter of the sleeve.

12. A vacuum wand as claimed in claim 1, wherein the sleeve is movable between an extended position, in which the contact surface of the sleeve is level with or below the contact surface of the nozzle, and a retracted position, in which the contact surface of the sleeve is above the contact surface of the nozzle.

13. A vacuum wand as claimed in claim 12, wherein the biasing mechanism comprises a spring.

14. A vacuum wand as claimed in claim 1, wherein retraction of the sleeve is limited by a shoulder of the wand body and co-operation between an upper flat surface of the sleeve and the wand body.

15. A vacuum wand as claimed in claim 1, wherein the sleeve is held in place on a distal end of the wand body by interlocking engagement with lugs.

16. A vacuum wand as claimed in claim 12, wherein a biasing force of the biasing mechanism is sufficient to return the sleeve from the retracted to the extended position, said biasing force being insufficient to dislodge a gemstone retained by the contact surface of the nozzle and/or the sleeve when the sleeve is returned to the extended position.

17. A transport mechanism for transporting cut gemstones, comprising a pivotable arm attached to a vacuum wand as claimed in claim 1.

18. A gemstone testing station comprising a device for orienting cut gemstones table down, a transport mechanism as claimed in claim 17, and an analysis instrument for carrying out analysis of the gemstones.

19. A screening device for determining whether a cut gemstone is natural or synthetic, including a testing station as claimed in claim 18.

20. A method of picking up a cut gemstone which has been orientated table down, comprising the steps of:
providing a vacuum wand having a generally cylindrical body with a central bore culminating in a nozzle through which a vacuum may be applied, said wand comprising a retractable outer sleeve, configured to slide axially over the nozzle and a biasing mechanism for biasing the sleeve towards a position in which it extends beyond the nozzle;
bringing the wand into contact with a pavilion of a gemstone;
applying a vacuum through the bore to the nozzle;
where the gemstone has a diameter greater than or equal to an internal diameter of the sleeve, retaining the gemstone by air pressure against the sleeve and/or the nozzle; or where the gemstone has a diameter smaller than the internal diameter of the sleeve, retracting the sleeve and retaining the gemstone by air pressure against the nozzle only.

21. A method of picking up a cut gemstone as claimed in claim 20, wherein the sleeve comprises a flat surface which co-operates with a flat surface of the cylindrical body to prevent rotation of the sleeve relative to the nozzle.

22. A method of picking up a cut gemstone as claimed in claim 20, wherein the nozzle comprises a tapered contact surface at a lower end thereof, said surface configured to retain a cut gemstone when vacuum is applied to the bore.

23. A method of picking up a cut gemstone as claimed in claim 20, wherein the sleeve comprises a generally conical contact surface at a lower end thereof, said surface configured to retain a cut gemstone when vacuum is applied to the bore.

24. A method of picking up a cut gemstone as claimed in claim 22, further comprising providing the contact surface of the nozzle with a profiled groove extending transversely therethrough.

25. A method of picking up a cut gemstone as claimed in claim 24, further comprising providing the contact surface of the sleeve with a profiled groove extending transversely therethrough, said groove being circumferentially aligned with the groove of the nozzle.

26. A method of picking up a cut gemstone as claimed in claim 23, wherein the sleeve is movable between an extended position, in which the contact surface of the sleeve is level with or below the contact surface of the nozzle, and a retracted position, in which the contact surface of the sleeve is above the contact surface of the nozzle.

27. A method of picking up a cut gemstone as claimed in claim 20, wherein the biasing mechanism comprises a spring.

28. A method of picking up a cut gemstone as claimed in claim 20, further comprising configuring a biasing force of the biasing mechanism to be sufficient to return the sleeve from the retracted to the extended position, but insufficient to dislodge a gemstone retained by the contact surface of the nozzle and/or the sleeve when the sleeve is returned to the extended position.

29. A method of picking up and transporting cut gemstones of a variety cuts and sizes which have been orientated table down, using the method of claim 20 and the same wand to pick up each gemstone.
